(19) United States
(12) Patent Application Publication
(10) Pub. No.: US 2005/0267965 A1
(43) Pub. Date: Dec. 1, 2005

(54) Mobile router graceful shutdown system and method

(75) Inventor: Amit Heller, Belmont, CA (US)

Correspondence Address: FARSHAD JASON FARHADIAN;CENTURY IP LAW GROUP, P.O. BOX 7333, NEWPORT BEACH, CA, 92658-7333, US

(73) Assignee: IXI Mobile (R&D) Ltd.

(21) Appl. No.: 10/846,197

(22) Filed: May 13, 2004

(51) Int. Cl. H04L 12/28

(52) U.S. Cl. 709/224

(57) ABSTRACT

In accordance with one aspect of the invention, a method for gracefully shutting down a communication router servicing one or more network servers in a personal area network is provided. The method comprises monitoring one or more communication sessions established between one or more network devices and the one or more network servers via the communication router; forwarding a termination message to at least one of the network servers, when it is determined that the communication router is shutting down; and closing a respective communication session between said at least one network server and one of the network devices.

### BACKGROUND

1. Field of Invention

The present invention relates generally to a system and method for gracefully shutting down a communication router and, more particularly, to managing communication sessions established by way of a mobile router between network servers and network devices, such that the communication sessions are terminated gracefully prior to router shutdown.

2. Copyright & Trademark Notices

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

3. Related Art

A communication device, such as a cellular phone, may be connected to a plurality of devices, such as digital cameras, wireless earpieces, wireless keyboards, etc. in a short-range communication network (e.g., a personal area network (PAN)). Further, a router may be embedded in the communication device to act as a bridge to connect user devices in the PAN to one or more server systems (or devices connected to said server systems), in a wide area communication network (WAN).

The servers can provide the devices connected in the PAN with various services. To accomplish this, the router establishes one or more lines of communication between the network devices and network servers and manages the respective communication lines. A communication line between a device and a server is generally established by way of a request to open a communication session between the device and the server.

Once the session is established, the router manages and controls data transfer based on a set of communication protocols, until the session is terminated. A communication protocol (e.g., a transmission control protocol/Internet Protocol (TCP/IP)) defines the set of control parameters that are to be packaged and transferred along with data, in order to maintain successful, timely and complete delivery of data.

A communication session established between a server and a device can be interrupted, if the router is turned off unexpectedly. As provided below, this interruption is more common and problematic in mobile communication systems (e.g., cellular networks) where the router is embedded in a cellular phone that is frequently turned on and off.

Obviously, sudden interruptions in communication are undesirable, particularly if the communicating parties are not aware of the interruption. For example, certain communication services, such as instant messaging services, rely on the status of a communication session between a device and the server to determine and display the connection status of a user to others.

When the communication session between the device and the server is terminated, as a result of the device or the server terminating the session, then the status of the user is updated to display the user as disconnected. However, if the communication session is abruptly terminated as a result of the router shutting down, the server system will not be notified of the disconnection, and will continue to erroneously display a connected status for the device, until a threshold time period has passed when the status is updated.

In current systems, when a router is shutdown, the standard protocol requirements for closing the connection and terminating the communication sessions between the communicating server and device are not followed. As a result, there is no way for the device or the server to gracefully notify or acknowledge the termination of the session. Thus, the server or the device may continue to communicate without the knowledge of the interruption.

The above problem may lead to loss of data that is pending in a queue for transmission. Furthermore, resources allocated to each communication session may remain open and useless until the devices or the server systems recognize that the connection has been interrupted and thereafter free those resources. Depending on implementation, it may take from several seconds to several hours before a device or a server realizes that a communication session has been abruptly terminated.

Therefore, a system and method is needed that can overcome the above shortcomings by providing a mechanism that timely notifies all servers and devices connected to the router of the router shutting down, so that all communication sessions are terminated gracefully.

### SUMMARY

The present disclosure is directed to a wireless communication system and corresponding methods for gracefully terminating a communication session between a network device and a network server connected via a communications router.

For the purpose of summarizing, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested.

In accordance with one aspect of the invention, a method for gracefully shutting down a communication router servicing one or more network servers is provided. The method comprises monitoring one or more communication sessions established between one or more network device and the one or more network servers via the communication router; forwarding a termination message to at least one of the network servers, when it is determined that the communication router is shutting down; and closing a respective communication session between said at least one network server and one or more network devices.

The method may further comprise transferring data pending in a transmit queue of the communication router to the corresponding network server, prior to closing the respective communication session. In certain embodiments, data pending in a transmit queue of the corresponding network server is forwarded to the communication router, prior to closing the respective communication session. In one embodiments, the communication router waits to receive an acknowledgement message from said at least one network server, prior to closing the respective communication session. The acknowledgement message indicates that the network server has received the termination message.

In another embodiment, a plurality of termination messages are forwarded to the at least one network server, when it is determined that the communication router is shutting down. The respective communication session is a transmission control protocol/Internet Protocol (TCP/IP) session, for example and the termination message comprises a FIN segment placed on a transmit queue of the communication router.

In one embodiment, a termination message is forwarded to all of the one or more network servers, when it is determined that the communication router is shutting down. The communication router may be embedded in a mobile communication terminal and the mobile communication terminal may be a cellular telephone.

In accordance with another embodiment, a system for gracefully shutting down a mobile router communicating with one or more network servers is provided. The system comprises means for monitoring one or more communication sessions established between the a network device and the one or more network servers via a communication router; means for forwarding a termination message to at least one of the one or more network servers, when it is determined that the communication router is shutting down; and means for closing a respective communication session between said at least one network server and the network device, prior to communication router shutting down.

The system may further comprise means for transferring data pending in a transmit queue of the communication router to the corresponding network server, prior to closing the respective communication session, and means for receiving data pending in a transmit queue of the corresponding network server, prior to closing the respective communication session.

In one embodiment, the system further comprises means for receiving an acknowledgement message from said at least one network server, prior to closing the respective communication session. The respective communication session may be a transmission control protocol/Internet Protocol (TCP/IP) session. The termination message comprises a FIN segment placed on a transmit queue of the communication router.

In yet another embodiment, a system for shutting down a mobile router in a personal mobile gateway (PMG) is provided. The system comprises a mechanism for monitoring a communication session established between a network device and a network server connected to a mobile router; a mechanism for determining when the mobile router is being turned off; a mechanism for warning the network server, prior to the mobile router being turned off; and a mechanism for terminating the communication session established between the network device and the network server.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1 is an exemplary communication environment illustrating exemplary communication sessions established between a network device and a plurality of network servers via a router, in accordance with one embodiment of the invention;

FIG. 2 is flow diagram of a method of gracefully shutting down the mobile router of FIG. 1, in accordance with one or more embodiments; and

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

A computing system and corresponding computer executable methods, according to an embodiment of the present invention, facilitate and provide a method for gracefully shutting down a mobile router to prevent abrupt interruption of any open communication sessions.

Numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

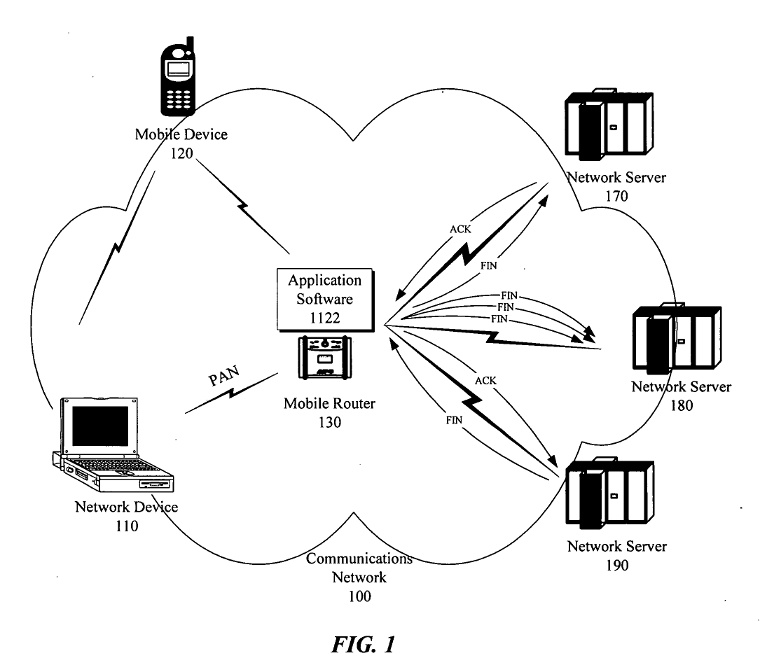

Referring to FIG. 1, in one or more embodiments of the present invention, a plurality of computing systems or devices (i.e., communications network 100, network device 110, mobile device 120, mobile router 130, network servers 170-190, etc.) may be arranged in wired and wireless communications networks to receive and transfer information. In alternative embodiments, certain devices may be connected either wirelessly or by wire in a non-networked environment to communicate data.

In one embodiment, mobile device 120 is connected in a wireless communications network 100. The wireless communications network 100 may be supported by a cellular service provider (e.g., Sprint, AT&T, Orange, etc.). In at least one embodiment, mobile device 120 is capable of communicating with a base station in wireless communications network 100 by way of a modem chipset utilizing communications technologies such as time division multiple access (TDMA), code division multiple access (CDMA), global systems for mobile communications (GSM), general packet radio service (GPRS), wideband CDMA (WCDMA) and other well-known wireless communications technologies.

One of ordinary skill in the art will appreciate that a communications network implemented according to the present invention may advantageously be comprised of various types of networks without detracting from the scope of the invention. Such networks, for example, may comprise local area networks (LANs), wide area networks (WANs), personal area network (PAN), public, private or secure networks, value-added networks, interactive television networks, two-way cable networks, satellite networks, interactive kiosk networks, cellular communications networks, personal mobile gateways (PMGs) and/or any other suitable communications network. A more detailed description of the PMG architecture is provided in U.S. patent application Ser. No. 09/850,399, filed on May 7, 2001, the entire content of which is hereby incorporated by reference here.

In accordance with one embodiment, mobile device 120 may comprise a mobile router 130 (e.g., a PMG device) or communicate with a self-contained mobile router 130, as shown in FIG. 1. Mobile router 130 is a miniature server system that is implemented to service wireless client devices connected in a personal area of a user. Mobile router 130 in association with network device 110, for example, forms a close-range wireless network (i.e., PAN) in which multiple network devices can communicate with one another as soon as a network device is situated within the proximate range of mobile router 130.

Advantageously, in certain embodiments, mobile router 130 and network device 110 are equipped with low-cost, low-power, short-range radio communication interfaces, supported by well-known wireless communication protocols (e.g., Bluetooth, IEEE 802.11, etc.) As such, network devices in the PAN can efficiently communicate with mobile router 130 and each other, so long ask the devices remain within the requisite distance.

Mobile router 130, in some embodiments, is directly or through mobile device 120 connected to one or more network servers 170-190 in communications network 100. As such, mobile router 130 acts as a gateway to connect network device 110 to one or more of network servers 170-190 in communications network 100. Communications network 100 may comprise a public switched telephone network (PSTN), a private system (e.g., cellular system) implemented with a number of switches, wire lines, fiber-optic cable, land-based transmission towers, space-based satellite transponders, or any other suitable communication system, such as a specialized mobile radio (SMR) system.

Mobile device 120, by way of example, may be one of a mobile computing device, a personal digital assistance, a cellular phone, or other wireless mobile device capable of communicating and connecting with wireless communications network 100. Network device 110, by way of example, may be a laptop computer, a monitor, a keyboard, an earpiece speaker microphone set, a personal digital assistance or other device capable of connecting and communicating with mobile router 130 over a wired or wireless communication connection, for example. Network servers 170-190 may be one or more of a presence server, a web server, a voice server, a file transfer server, or other type of server supporting communication services such as instant messaging, Internet browsing, voice over IP, or FTP, for example.

One or more or a combination of wireless and wired communication technologies suited for connecting computing devices in short-range or long-range area networks and the like may be utilized, in certain embodiments, to connect mobile router 130 to network servers 170, 180, 190 and network device 110, for example. The terms “connected,” “coupled,” or any variant thereof, mean any connection or coupling, either direct or indirect, between two or more elements. The coupling or connection between the elements can be physical, logical, or a combination thereof.

In certain embodiments, application software 1122 is executed on mobile router 130, for example, to monitor the connections and data communicated between network device 110 and network servers 170-190. In certain embodiments, application software 1122 is dedicated to managing and monitoring telephony events associated with opening and closing communication sessions over a communication connection established between network device 110 and at least one of network servers 170-190.

As used herein, the terms mobile device, mobile router, network device, network server and communications network are to be viewed as designations of one or more computing environments that comprise application, client or server software for servicing requests submitted by respective software applications included in devices or other computing systems connected thereto. These terms are not to be otherwise limiting in any manner. The application software 1122, for example, may be comprised of one or more modules that execute on one or more integrated or distributed computing environments.

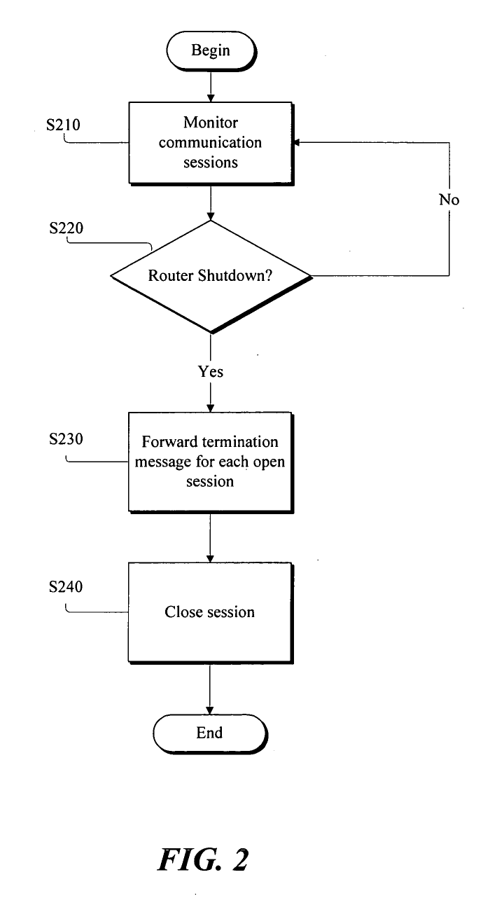

Referring to FIGS. 1 and 2, in accordance with one embodiment, application software 1122 is executed on mobile router 130 to monitor one or more communication sessions established between network device 110 and respective network servers 170-190 (S210). A session is established between network device 110 and one or more of the network servers 170-190 according to a communication protocol implemented to manage data transmissions, for example, in a wireless mobile communications network.

In a certain preferred embodiment, the mobile wireless network is implemented using a combination of Bluetooth technology and the transmission control protocol/Internet Protocol (TCP/IP) over a cellular communication interface. While a preferred embodiment of the invention is described in the following as utilizing Bluetooth and TCP/IP communication technologies in a cellular communications network, it is noteworthy that other embodiments may be implemented over any type of wired or wireless telephony or communication technology or protocol suited for the purposes of this invention, wherein a mobile, a stationary, or other type of router is utilized to manage communication between server and client systems connected in a communications network. Therefore, the scope of the invention shall not be construed as limited to the specific embodiments provided herein.

Referring back to FIGS. 1 and 2, if application software 1122 detects that mobile router 130 is being shutdown (S220), then application software 1122 forwards a termination message to each network server 170-190 that maintains an open session with a network device 110, via mobile router 130 (S230). In this manner, application software 1122 notifies network servers 170-190 that mobile router 130 is shutting down (i.e., powering off), so that network servers 170-190 discontinue communicating with network device 110 by way of mobile router 130.

When one or more of network servers 170-190 receive the termination message, each respective network server transfers, for example, data pending in its transmit queue, and closes the session established with mobile router 130 (S240). In one embodiment, resources allocated to the open session in each network server 170-190 are freed after the session is closed, so that other processes or applications executing on the network server can use the resources that have become available. As such, forwarding a termination message to each network server 170-190, in advance of mobile router 130 shutting down, prevents data loss or indefinite allocation of resources.

Referring back to FIG. 1, a communication session between network device 110 and network servers 170-190 may be closed in various manners, depending on implementation. In the following, exemplary methods for termination of a TCP session are provided. One skilled in the art would understand, however, that other implementations are also possible. Further, the provided exemplary methods may be utilized either individually or in combination to accomplish the designated tasks in either a TCP or other communication environment.

Referring to network server 170, in one embodiment, application software 1122 after detecting that mobile router 130 is shutting down places a FIN segment on mobile router 130's transmit queue. Then application software 1122 transmits all pending data in the queue routed for network server 170 along with the FIN segment to network server 170. The FIN segment marks the end of the data to be transmitted from mobile router 130 prior to it shutting down. In certain embodiments, it further indicates that the TCP session is about to be closed by mobile router 130.

In one embodiment, network server 170 after receiving the FIN segment forwards an ACK segment to mobile router 130, acknowledging receipt of the FIN segment. Application software 1122 waits to receive the ACK segment from network server 170 before mobile router 130 shuts down. Once the ACK segment is received, then application software 1122 closes the TCP session. Thereafter, mobile router 130 is powered off. In this manner, application software 1122 ensures that all data queued for transmission from mobile router 130 have been transmitted and received by network server 170.

Referring to network server 180, in another embodiment, when application software 1122 detects that mobile router 130 is shutting down, application software 1122 places one or more FIN segments on mobile router 130's transmit queue. The one or more FIN segments are transmitted from mobile router 130 to network server 180 along with the pending data in the transmit queue. Application software 1122 thereafter closes the communication session between mobile router 130 and network server 180, without waiting for an ACK segment to be received from network server 180. In some embodiments, application software 1122 applies a time out procedure, such that if an ACK is not received from the network server 130 within a threshold time period, then the session is closed.

In the above embodiment, transmitting several FIN segments increases the probability that network server 180 will receive at least one of the FIN segments, even if some of the FIN segments are not delivered due to an error in communication or loss of signal, for example. This redundancy ensures that network server 180 is notified that mobile router 130 intends to close the TCP session and shutdown. In other embodiments, mobile router 130 may, regardless of sending a plurality of FIN segments, wait to receive an ACK segment from network server 180 before closing the TCP session.

Referring to network server 190, in yet another embodiment of the invention, network server 190 may be shutting down while connected to mobile router 130. Accordingly, prior to shutting down, network server 190 transmits a FIN segment to mobile router 130. Upon receiving the FIN segment, application software 1122 transmits an ACK segment to network server 190 along with all data pending in the transmit queue of mobile router 130. Thereafter, application software 1122 closes the TCP session between mobile router 130 and network server 190.

Accordingly, network devices 170-190 can be gracefully notified of the termination of pending communication session with network device 110, prior to mobile router 130 shutting down. This will ensure that each network server can update the respective status for network device 110, so that other network devices connected to communications network 100 can be notified of the change in status of network device 110. For example, if server device 170 is an instant messaging (IM) server, then server device 170 would change the IM status for network device 110 to unavailable or disconnected upon receiving the respective FIN segment from mobile router 130.

Referring to network device 110, in certain embodiments of the invention, similar methods as provided above may be applied to notify network device 110 of mobile router 130 shutting down. As such, both the network device 100 and network servers 170-190 in the communications network 100 can be notified of the router's shutting down in advance, so that each device or server in the communications network 100 can accordingly update the connection status of the other devices in the communications network 100.

In some embodiments, the monitoring, forwarding, and other functions discussed above in relation to application software 1122 are implemented in hardware, or a combination of hardware and software. As such, although application software 1122 is disclosed as applicable to the system of the present invention, this application is by way of example and shall not be construed to limit the scope of the invention to a software solution.

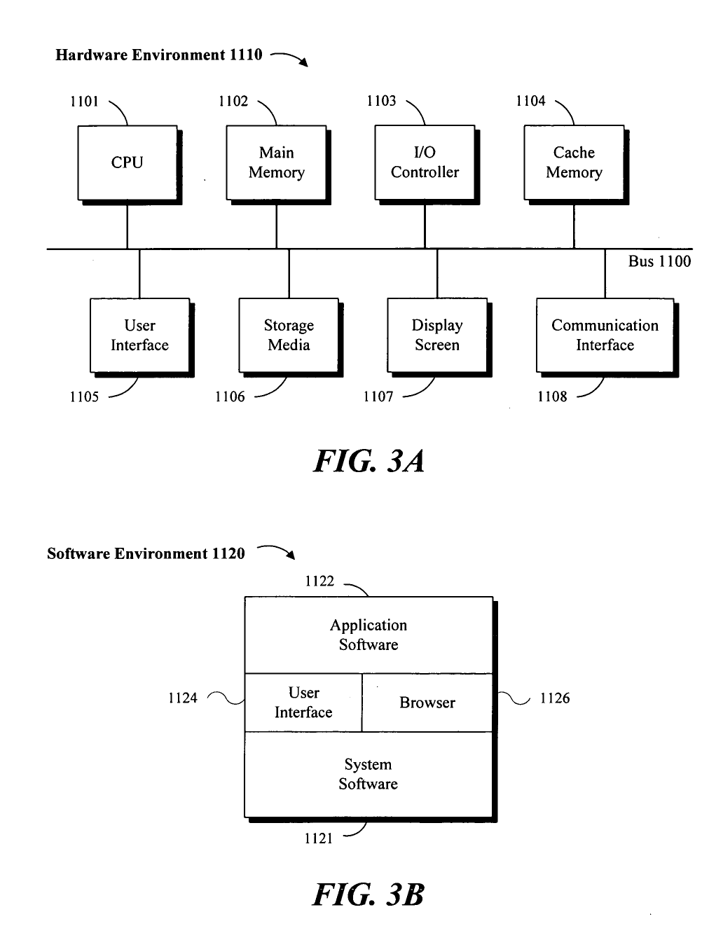

In embodiments of the system, communication network 100, network device 110, mobile device 120, mobile router 130, network servers 170-190, and equivalents thereof, comprise a controlled system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments of the invention.

Software environment 1120 is divided into two major classes comprising system software 1121 and application software 1122. System software 1121 comprises control programs, such as the operating system (OS) and information management systems that instruct the hardware how to function and process information. Application software 1122 is a program that performs a specific task, such as gracefully shutting down mobile router 130. In certain embodiments of the invention, system and application software are implemented and executed on one or more hardware environments, for example.

Referring to FIG. 3A, an embodiment of the application software 1122 can be implemented as logic code in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a wireless network card, a Blue tooth port, a wireless modem, etc.), and a system synchronizer (e.g., a clock, not shown in FIG. 3A).

Cache memory 1104 is utilized for storing frequently accessed information. A communication mechanism, such as a bi-directional data bus 1100, can be utilized to provide for means of communication between system components. Hardware Environment 1110 is capable of communicating with local or remote systems connected to a wireless communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless communication unit (e.g., cellular phone), or other similar hardware platforms that have information processing and/or data storage and communication capabilities. For example, in one or more embodiments of the system, hardware environment 1110 may comprise a PMG unit or an equivalent thereof.

In embodiments of the system, communication interface 1108 can send and receive electrical, electromagnetic, or optical signals that carry digital data streams representing various types of information including program code. If communication is established via a communications network, hardware environment 1110 may transmit program code through the network connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are memory cards, CD-ROM disks, ROM cards, floppy disks, magnetic tapes, computer hard drives, and network server systems.

In one or more embodiments of the invention, processor 1101 is a microprocessor manufactured by Motorola, Intel, or Sun Microsystems Corporations, for example. The named processors are for the purpose of example only. Any other suitable microprocessor, microcontroller, or microcomputer may be utilized.

Referring to FIG. 3B, software 1120 or one or more of its components is stored in storage media 1106 and is loaded into memory 1102 prior to execution. Software environment 1120 comprises system software 1121 and application software 1122. Depending on system implementation, certain aspects of software environment 1120, and particularly application software 1122, can be loaded on one or more hardware environments 1110, or subcomponents thereof.

System software 1121 comprises software such as an operating system that controls the low-level operations of hardware environment 1110. Low-level operations comprise the management of the system resources such as memory allocation, file swapping, and other core computing tasks. In one or more embodiments of the invention, the operating system can be Symbian, Nucleus, Microsoft Windows, Palm, or Linux operating system, for example. However, any other suitable operating system may be utilized.

Application software 1122 can comprise one or more computer programs that are executed on top of system software 1121 after being loaded from storage media 1106 into memory 1102. In a client-server architecture, application software 1122 may comprise client software and/or server software. Referring to FIG. 1, for example, in one embodiment of the invention, client software is executed on network device 110, network servers 170-190, and server software is executed on mobile router 130 or mobile device 120.

Software environment 1120 may also comprise web browser software 1126 for accessing content on a remote server. Further, software environment 1120 may comprise user interface software 1124 (e.g., a Graphical User Interface (GUI)) for receiving user commands and data. The received commands and data are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods for gracefully shutting down a mobile router 130. In this exemplary embodiment, logic code for performing these methods is implemented in the form of, for example, application software 1122. The logic code, in one embodiment, may be comprised of one or more modules that execute on one or more processors in a distributed or non-distributed communication model. For example, one or more embodiments of the present invention may comprise separate radio and baseband modules, or alternatively modules incorporating the radio, baseband, micro-controller and flash memory in a single-chip solution.

It should also be understood that the programs, modules, processes, methods, and the like, described herein are but exemplary implementations and are not related, or limited, to any particular computer, apparatus, or computer programming language. Rather, various types of general-purpose computing machines or customized devices may be used with logic code implemented in accordance with the teachings provided, herein. Further, the order in which the methods of the present invention are performed is purely illustrative in nature. These methods can be performed in any order or in parallel, unless indicated otherwise in the present disclosure.

The methods of the present invention may be performed in either hardware, software, or any combination thereof. In particular, some methods may be carried out by software, firmware, or macrocode operating on a single computer a plurality of computers. Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention. Other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method of gracefully shutting down a communication router servicing one or more network servers, the method comprising:
monitoring one or more communication sessions established between the one or more network servers and one or more network devices, via the communication router;
forwarding a termination message to at least one of the network servers, when it is determined that the communication router is shutting down; and
closing a respective communication session between said at least one network server and at least one of the network devices.

2. The method of claim 1, further comprising:
transferring data pending in a transmit queue of the communication router to a corresponding network server, prior to closing the respective communication session.

3. The method of claim 1, wherein said at least one network server updates connection status information for the one or more network devices, upon receiving the termination message from the communication router.

4. The method of claim 1, further comprising:
waiting for a threshold time period to receive an acknowledgement message from said at least one network server, prior to closing the respective communication session.

5. The method of claim 1, further comprising:
forwarding a plurality of termination messages to said at least one network server, when it is determined that the communication router is shutting down.

6. The method of claim 4, wherein the acknowledgement message indicates that the network server has received the termination message.

7. The method of claim 1, wherein the respective communication session is a transmission control protocol/Internet Protocol (TCP/IP) session.

8. The method of claim 7, wherein the termination message comprises a FIN segment placed on a transmit queue of the communication router.

9. The method of claim 1, wherein a termination message is forwarded to all of the one or more network servers, when it is determined that the communication router is shutting down.

10. The method of claim 1, wherein the communication router is a mobile router.

11. The method of claim 10, wherein the mobile router is embedded in a cellular telephone.

12. A system for gracefully shutting down a router connecting one or more network servers to one or more network devices in a communications network, the system comprising:
means for monitoring one or more communication sessions established between the one or more network servers and the one or more network devices via the communication router and;
means for forwarding a termination message to at least one of the one or more network servers, when it is determined that the communication router is shutting down; and
means for closing a respective communication session between at least one of the network servers and one of the network devices connected via the communication router.

13. The system of claim 12, further comprising:
means for transferring data pending in a transmit queue of the communication router to the at least one network server, prior to closing the respective communication session.

14. The system of claim 12, further comprising:
means for receiving data pending in a transmit queue of the at least one network server, prior to closing the respective communication session.

15. The system of claim 12, further comprising:
means for receiving an acknowledgement message from said at least one network server, prior to closing the respective communication session.

16. The system of claim 12, wherein the respective communication session is a transmission control protocol/Internet Protocol (TCP/IP) session.

17. The system of claim 16, wherein the termination message comprises a FIN segment placed on a transmit queue of the communication router.

18. The system of claim 12, wherein the communication router is embedded in a mobile communication terminal.

19. The system of claim 12, wherein the mobile communication terminal is a cellular telephone.

20. A system for shutting down a mobile router, the system comprising:
a mechanism for monitoring a communication session established between the mobile router and a network server;
a mechanism for determining when the mobile router is being turned off;
a mechanism for warning the network server, prior to the mobile router being turned off; and
a mechanism for terminating the communication session established between the mobile router and the network server.
